(19) United States
(12) Patent Application Publication
(10) Pub. No.: US 2023/0202652 A1
(43) Pub. Date: Jun. 29, 2023

(54) DRONE

(71) Applicant: OCTOFAN SAS, Courbevoie (FR)

(72) Inventor: Pierre Convert, Courbevoie (FR)

(21) Appl. No.: 17/645,752

(22) Filed: Dec. 23, 2021

(51) Int. Cl. B64C 29/00; B64C 3/54; B64C 11/00; B64C 11/48; B64C 39/02; B64C 39/08

(52) U.S. Cl. CPC B64C 29/0033; B64C 3/54; B64C 11/001; B64C 11/48; B64C 39/024; B64C 39/08; B64C 2201/088; B64C 2201/042; B64C 2201/102; B64C 2201/162

(57) ABSTRACT

The aircraft comprises a fuselage defining a fuselage main axis. The fuselage comprises a docking system for fixing removable nacelles. The aircraft has wings equipped with tilting actuators for rotating wings about rotation axes parallel to the fuselage main axis and at least six propellers mechanically connected to the fuselage. The aircraft also has at least one cryo-hydrogen tank and at least one fuel cell for supplying power to the propellers, and

A capacitor for supplying power to the propellers, charged by at least one fuel cell. This capacitor stores electrical energy greater than the energy needed by all the propellers for ten seconds of hovering flight. Each propeller is equipped with a tilting actuator for rotating the propeller about a rotation axis making an angle of less than 45 degrees with a plane perpendicular to the fuselage main axis. The fuselage having a forward and a rear portion defining a forward to rear order of the propellers, in cruise flight, the two forward propellers are activated to provide vertical thrust, the intermediate propellers between the forward and rearmost propellers are not activated and the two rearmost propellers are activated to provide horizontal thrust.

### TECHNICAL SCOPE OF THE INVENTION

The present invention relates to an aircraft. It applies, in particular, to the fields of transporting goods or passengers and to fighting fires and other natural or industrial disasters.

### STATE OF THE ART

To increase emergency resources and solve transport congestion, the use of aircrafts, otherwise known as unmanned aircrafts, is being considered. Global warming is increasing the number and severity of natural disasters, including forest fires, floods, and storms. To reinforce the means of intervention, it is necessary to transport higher loads, faster and closer to the point of need.

Moreover, crowded giant cities reinforce the need to use the vertical dimension for emergency reasons and critical deliveries first, for public and private transport second.

However, the use of additional means of air transport has so far led to an increase in the fossil energy consumed, which means an increase in CO₂.

The transport of people or freight, in particular containers, standardized swap bodies, on classic routes of 200 to 2,000 km, faces several difficulties.

On the one hand, natural ground obstacles require the installation and maintenance of infrastructure (e.g., roads, bridges, tunnels, railways). On the other hand, the proximity of inhabited areas prohibits noisy transports, such as helicopters.

These helicopters have other disadvantages:
the tilt of the helicopter, necessary for horizontal acceleration, causes discomfort to passengers and damage to cargo,
turbulence in the vicinity of cliffs or buildings destabilizes helicopters—pilot corrections are limited by the pilot's reflex time, the inertia of the propulsion chain and the degrees of freedom of the aircraft,
the wingspan of the propeller combined with this instability requires safety margins that impose a minimum distance from obstacles,
the mechanics of their propulsion, based on an internal combustion engine, require a high level of maintenance,
the uniqueness of the propulsion chain completely exposes the mission to the risk of failure,
the payload ratio is low, which leads to a limited range and more refueling.

In the particular case of forest fires, the various technical means currently available all suffer from major drawbacks:
regarding water-transport aircraft, for example the Canadair (registered trademark), the non-gradual opening of their release hatch and their altitude constrained by the ridges, limit the accuracy of their watering of the fire and the percentage of water arriving on the target,
the helicopter is more accurate but slower and carries much less water and
land vehicles are hampered by obstacles in the terrain (relief, slope, forest, river, etc.), including in urban areas (buildings, urban furniture), and their speed of travel is limited as is their capacity to carry water.

The transport of people or freight, in particular containers, standardized swap bodies, on classic routes of 200 to 2,000 km, faces several difficulties.

On the one hand, natural ground obstacles require the installation and maintenance of infrastructure (e.g., roads, bridges, tunnels, railways). On the other hand, the proximity of inhabited areas prohibits noisy transports, such as helicopters.

These helicopters have other disadvantages:
the tilt of the helicopter, necessary for horizontal acceleration, causes discomfort to passengers and damage to cargo,
turbulence in the vicinity of cliffs or buildings destabilizes helicopters—pilot corrections are limited by the pilot's reflex time, the inertia of the propulsion chain and the degrees of freedom of the aircraft,
the wingspan of the propeller combined with this instability requires safety margins that impose a minimum distance from obstacles,
the mechanics of their propulsion, based on an internal combustion engine, require a high level of maintenance,
the uniqueness of the propulsion chain completely exposes the mission to the risk of failure,
the payload ratio is low, which leads to a limited range and more refueling.

In the particular case of forest fires, the various technical means currently available all suffer from major drawbacks:
regarding water-transport aircraft, for example the Canadair (registered trademark), the non-gradual opening of their release hatch and their altitude constrained by the ridges, limit the accuracy of their watering of the fire and the percentage of water arriving on the target,
the helicopter is more accurate but slower and carries much less water and
land vehicles are hampered by obstacles in the terrain (relief, slope, forest, river, etc.), including in urban areas (buildings, urban furniture), and their speed of travel is limited as is their capacity to carry water.

### Presentation of the Invention

The present invention is intended to remedy some or all of these drawbacks.

To this end, according to a first aspect, the present invention aims at an aircraft comprising a fuselage defining a fuselage main axis, at least six propellers mechanically connected to the fuselage, and, for each of at least two of these propellers, a tiling actuator for rotating this propeller about a rotation axis making an angle of less than 45 degrees with a plane perpendicular to the fuselage main axis, thus allowing for a vectorized thrust, that can also generate pitch and yaw torque.

By rotating the two or more steerable propellers, the aircraft can turn on itself, compensate for wind during take-off or landing, accelerate in flight, hover, and reduce its flight speed.

In particular embodiments, the fuselage has a forward portion and a rear portion defining a forward to rear order of propellers, wherein each one of rearmost propellers is part of the at least two propellers associated with the tilting actuators. In such embodiments, the rotation of the rearmost propellers to achieve horizontal thrust prevents another propeller from being in the air stream propelled by each of these rearmost propellers.

In particular embodiments, the aircraft comprises at least four propellers associated with tilting actuators. Such embodiments improve the handling of the aircraft.

In particular embodiments, all of the propellers are among the at least two propellers provided with steering actuators. In such embodiments, the handling of the aircraft is thus further improved.

In particular embodiments, the fuselage has a forward portion and a rear portion defining a forward to rear order of propellers, the aircraft comprises eight propellers, each of said propellers being associated with a tilting actuator. The presence of eight propellers improves the stability of the aircraft as well as its safety in the event of a propeller failure.

In particular embodiments, in cruise flight, six forward propellers are oriented along vertical axes and two rearmost propellers are oriented along horizontal axes. The six forward propellers thus create minimal drag.

In particular embodiments, in cruise flight, two rearmost propellers are activated to provide horizontal thrust, and six forward propellers are not activated. This distribution of propeller activations, at least two of which, and four in case of an eight-propeller aircraft, are off, increases the range of the aircraft.

In particular embodiments, between take-off and cruise flight, the six forward propellers are successively oriented along vertical axes and activated to provide vertical thrust, then oriented with a progressive tilting angle and activated to provide oblique thrust and then oriented with a degressive tilting angle until being oriented along vertical axes. This distribution of propeller activations allows smooth transition between vertical take-off acceleration and horizontal cruise speed.

In particular embodiments, between cruise flight and landing, the six forward propellers are successively oriented with a progressive tilting angle and activated to provide oblique thrust and then oriented with a degressive tilting angle until being oriented along vertical axes and activated to provide vertical thrust. This distribution of propeller activations also allows smooth transition between vertical take-off acceleration and horizontal cruise speed.

In particular embodiments, during U-turn, at least a frontmost propeller on one side of the aircraft and at least a rearmost propeller on the other side of the aircraft are oriented along oblique axes having opposite tilting angles.

In particular embodiments, the aircraft comprises wings positioned above a plane of the propellers. In such embodiments, the wings increase the range of the aircraft.

In particular embodiments, the wings have a curved shape with a concavity facing downward. The curved shape increases the distance between the wings and the propellers and reduces the impact of the wings on the airflow into the propellers.

In particular embodiments, a maximum wingspan is less than a length of the aircraft. In such embodiments, the aircraft is thus very compact, both in flight and on the ground, which allows for a denser parking area and a reduction in the risk of collision.

In particular embodiments, the aircraft comprises wings associated with tilting actuators for rotating wings about axes of rotation parallel to a fuselage main axis, resulting in ability to tighten wingspan in flight phase where less relying on wing lift.

In particular embodiments, each propeller comprises ducted fans. The ducted fans reduce noise generated by the aircraft.

In particular embodiments, each propeller comprises counter-rotating fans. This counter-rotating arrangement of the propellers reduces the noise caused by the aircraft. For example, a noise of the order of 40 dB at 1,000 meters, without the attenuation device, has been measured with a prototype of the aircraft which is the subject of the invention.

In particular embodiments, the aircraft comprises at least one cryo-hydrogen tank and at least one fuel cell for powering the propellers. In such embodiments, the aircraft does not emit greenhouse gases, NOx, CO₂, or fine particles and does not pollute its environment, neither at take-off, nor in flight, nor on landing. It can therefore be used in cities or in particularly fragile sites.

In particular embodiments, the aircraft comprises a capacitor for supplying electrical power to the propellers, charged by at least one fuel cell, said capacitor storing electrical energy greater than the energy needed by all the propellers for ten seconds of hovering flight. In such embodiments, the capacitor compensates for the time needed by each fuel cell to reach full power.

In particular embodiments, the fuselage comprises a removable nacelle docking system. The aircraft can thus quickly change its load from a passenger transport mission to a cargo transport, rescue, or fire-fighting mission, for example.

In particular embodiments, the aircraft includes an attitude compensator that distributes electrical power to the propellers to counterbalance attitude variations. This improves the comfort of any passengers and the safety of any goods transported.

According to a second aspect, the present invention aims at an aircraft comprising
a fuselage defining a fuselage main axis, comprising a removable nacelle docking system,
at least eight propellers comprising counter-rotating ducted fans, said propellers being mechanically connected to the fuselage, and, for each of the propellers, a tiling actuator for rotating this propeller about a rotation axis making an angle of less than 45 degrees with a plane perpendicular to the fuselage main axis,
at least one cryo-hydrogen tank and at least one fuel cell for powering the propellers,
a capacitor for supplying electrical power to the propellers, charged by at least one fuel cell, said capacitor storing electrical energy greater than the energy needed by all the propellers for ten seconds of hovering flight, and
wings positioned above a plane of the propellers, the wings having a curved shape with a concavity facing downward, the wings being associated with tilting actuators for rotating wings about axes of rotation parallel to a fuselage main axis, resulting in ability to tighten wingspan in flight phase where less relying on wing lift;
wherein, in cruise flight, six forward propellers are oriented along vertical axes and two rearmost propellers are oriented along horizontal axes and activated to provide horizontal thrust, and four intermediate propellers between the forward and rearmost propellers are not activated; and
wherein, between take-off and cruise flight, the six forward propellers are successively oriented along vertical axes and activated to provide vertical thrust, then oriented with a progressive tilting angle and activated to provide oblique thrust and then oriented with a degressive tilting angle until being oriented along vertical axes.

### BRIEF DESCRIPTION OF THE FIGURES

Further advantages, purposes and particular features of the invention will be apparent from the following non-limiting description of at least one particular embodiment of the aircraft subject of the present invention, with reference to the appended drawings, in which:

FIG. 1 represents, in perspective, a first particular embodiment of the aircraft subject of the invention, in a parked configuration,

FIG. 2 shows, in perspective, the aircraft illustrated in FIG. 1, in take-off or landing configuration,

FIG. 3 shows, in perspective, the aircraft shown in FIGS. 1 and 2, in the in-place rotation configuration,

FIG. 4 shows, in perspective, the aircraft illustrated in FIGS. 1 to 3, in a low speed flight configuration,

FIG. 5 shows, in perspective, the aircraft illustrated in FIGS. 1 to 4, in a high-speed flight configuration,

FIG. 6 represents, in perspective, the aircraft illustrated in FIGS. 1 to 5, in cruise-flight configuration,

FIG. 7 represents the control and command elements of the various wings and propellers tilting actuators of the aircraft illustrated in FIGS. 1 to 6,

FIG. 8 represents a mobile wing root and its mobility organs of the aircraft illustrated in FIGS. 1 to 7,

FIG. 9 represents, in the form of a block diagram, the main components of the aircraft illustrated in FIGS. 1 to 8,

FIG. 10 represents, in top view, a second mode of implementation of the aircraft subject of the invention, in hovering flight configuration, and

FIG. 11 shows, in top view, the aircraft illustrated in FIG. 10, in flight configuration.

### DESCRIPTION OF METHODS OF IMPLEMENTATION

The present description is non-limiting, and each feature of one embodiment may be combined with any other feature of any other embodiment in an advantageous manner.

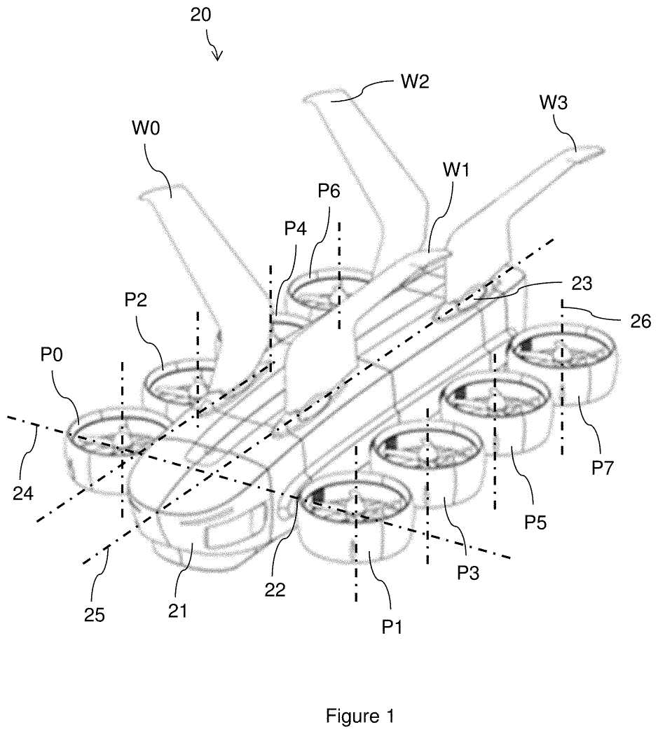

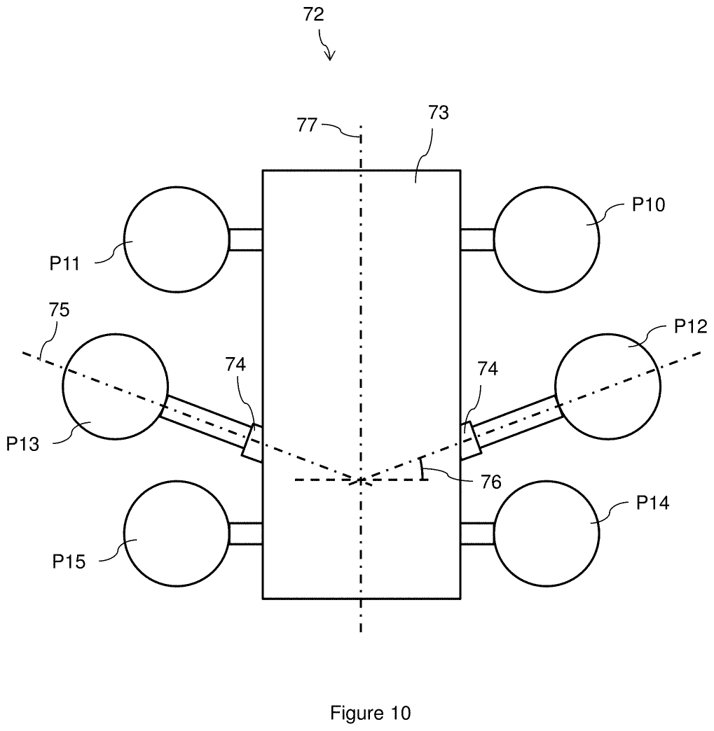

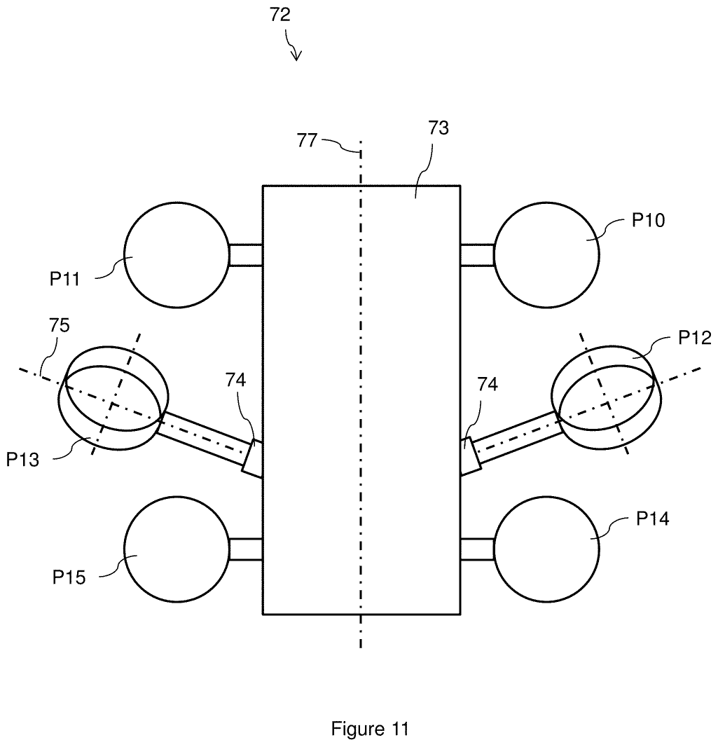

Throughout the description, the term “upper” or “top” or “top-over” is used to refer to what is at the top in FIGS. 1 to 6 and 8, which correspond to the normal layout of the aircraft. The term “lower” or “bottom” is used to refer to what is below in these FIGS. 1 to 6. The notions of “vertical” and “height” follow from these definitions. The term “front” is used to refer to the lower left in FIGS. 1 to 6 and the upper left in FIGS. 10 and 11, which corresponds to the forward direction of the aircraft when in motion, and the term “rear” is used to refer to the upper right in FIGS. 1 to 6 and the lower right in FIGS. 10 and 11. Measurements in the forward-to-rearward direction, i.e., parallel to a fuselage main axis, or parallel to a horizontal axis of the vertical plane of symmetry of the aircraft, are referred to as “length”. What is to the right of the aircraft when viewed from its rear to its front is called “right” or “right”, and what is to the left in this aspect is called “left”. The dimensions measured along an axis perpendicular to the plane of symmetry of the aircraft are called “width”. Internal” or “inside” is what is close to or oriented towards the fuselage main axis, and “external” or “external” is what is further away from this axis or oriented away from this axis.

We can define three planes of reference. The first reference plane, the main symmetry plane (vertical plane of symmetry above), is the plane for which the machine exhibits a left-right symmetry. The main symmetry plane contains the line which is colinear with the direction of cruising and which is going through the center of mass of the aircraft. The second reference plane, the top plane, contains also the center of mass of the aircraft, is orthogonal to the main symmetry plane and parallel to the propellers tilting axis. The top plane is perpendicular to the thrust direction when the aircraft is hovering in perfectly calm atmosphere. The top plane is oriented such that the normal vector is mostly pointing in the opposite direction of thrust when the aircraft is hovering, that is to say mostly upward at rest. The third reference plane, the front plane, is orthogonal to both main symmetry plane and top plane, contains the center of mass of the aircraft and has normal vector pointing in the main direction of forward movement of the aircraft.

Let us index the propellers with letter “P” followed by numbers varying from 0 to 7, such that left side propeller indices have even numbers and right side have odd numbers, and such that indices always increases when going from the front of the craft to the back of the craft. Thus, the foremost propellers have indices P0 and P1. The rearmost propellers have indices P6 and P7. We define the propeller main vector as coincident with the rotational axis of its fans and pointing in the opposite direction of the averaged mass flow direction, which is to say pointing towards us when facing the propeller suction front surface.

We define the tilting angle as the following as the angle between the projection of the propeller main vector on the main symmetry plane and the top plane normal vector. This implies that the propeller main vector is parallel and of same direction compared to the top plane vector when titling angle is zero, the propeller main vector is parallel and of same direction compared to the front plane vector when titling angle is 90 degrees. The propeller main vector is parallel and of opposite direction compared to the front plane vector when titling angle is (minus) −90 degrees.

We define the propeller thrust against a normalized scale, 0% being fully stopped, 100% being the thrust that, when set on all propellers, balances thrust and nominal weight in the hovering position. The propellers are designed in a way that allows for a true maximal thrust of 200% and can therefore be used in the entire 0% to 200% range. We also state that two propellers whose thrust are set to 50% and tilting angles are 90 degrees are sufficient to compensate drag and maintain cruise velocity.

The present invention, with all previously described characteristics, is intended to remedy many drawbacks of nowadays ground transportation system on a significant number of long-term goals detailed in what follows.

First, it will help adding a strong momentum in carbon dioxide emissions reduction current move by providing a drop-in hydrogen-powered replacement solution with enhanced characteristics compared to conventional means.

Second, by drastically reducing the need for new ground infrastructures like highways, bridges, railroads, airport fields, it will help preserve natural land, reduce forest splitting, minimize our impact on biodiversity and spare significant amount of CO₂ emitting resource like concrete, tar and gas; the proposed invention being a vertical take-off and landing multipurpose craft whose ground infrastructure requirement are by some order of magnitude lower than competing transportation means (trains, trucks, airplanes).

Third, by turning large parts of road traffic to airborne solutions, it will help to effectively fight against microplastics, whose insidious and poisonous has been well-documented. For instance, they sediment in Blood of many animals since plastics cross their barriers membranes, making their way into the bloodstreams of many food chain primers and then are passed along to the humans and raise an explosive health issue, not to mention global-scale far-reaching soils pollution, impact on wildlife and so on. Since 35% of microplastics originated (https://www.statista.com/chart/17957/where-the-oceans-microplastics-come-from/) from Tire & Road Wear Particles, we see that zero emissions tire-based solution is by no means a fully acceptable solution.

Fourth, it will help increasing the energy efficiency of the system as a whole (which is different from moving to full renewable, the point here is, even with renewable-originated power, to reduce power consumption and therefore reduce renewable power generation negative side-effects like land use), by simply shortening the travelled distance, moving-away of the hub-based transport architecture which imply massive waste, promoting shortest route point to point transportation. This is also a major edge compared to ground-based transportation which rely on infrastructures always preventing straight routes.

To be able to put in practice the four points listed above, the invention is crafted in such a way that it brings significant advantages on a well-balanced and carefully selected set of primary six specific metrics, that, when elevated to the proper level, enables the invention to reach these long-term goals.

The first feature that is selected as arising from the present invention is an inherently higher level of safety for the craft. Mass transportation immediately translates to some orders of magnitude higher number of flights and the safety level must evolve in the same proportion to maintain the new transport framework to be based on the invention safe enough to become a backbone solution. The present invention should be able to raise the level of safety by at least one order of magnitude in terms of catastrophic failure probability compared to most current aircrafts able to carry payloads heavier than five tons while being capable of vertical take-off and landing, a good example of which are heavy conventional turbine-powered helicopters or heavy electrical quadcopters.

The key metric for this safety feature is the number of incidents triggering an emergency landing per hour of flight. The target of the present invention for this metric is a level of one such incident per 360,000 hours of flight, equivalent to best-in-class jet engines airliners.

The second feature that would arise from the present invention is a higher level of sustainability, which breaks down in two sub aspects: energy efficiency and a power source compatible with intermittent renewable power generation (solar and wind concentrating the biggest part of investment in new renewable power generation capabilities deployment for two decades). A lot of well-documented factors advocates to take extra care of energy efficiency of the aircraft, few among them are: Since Global Warming, resource scarcity, cost of energy transition, need for faster adoption rates. The present invention should be able to raise the level of energy efficiency by significantly reducing the energy consumption on typical duties, like, more specifically, reducing by a half the energy consumption for a 20-minute flights at a nominal cruising speed of 190 km/h and under a six tons payload, while cruising at a 1,000 meters altitude, compared to most current aircrafts able to carry payloads heavier than five tons while being capable of vertical take-off and landing, a good example of which are heavy conventional turbine-powered helicopters or heavy electrical quadcopters.

The third feature that would arise from the present invention is a higher level of compactness while near ground. This compactness is a key enable for the density of packing of machines described in this invention and plays a significant role into allowing closer to the target operation and point to point linking. More specifically, the area of the ground projection, all parts included, of the aircraft in parking position and final descent phase of ascent initial phase, must be kept at least two times lower than any aircrafts able to carry payloads heavier than five tons while being capable of vertical take-off and landing, a good example of which are heavy conventional turbine-powered helicopters or heavy electrical quadcopters.

The fourth feature that would arise from the present invention is an increased agility. This feature can be characterized by three advantages: First part of this agility feature would be a superiority in terms of being able to execute trajectories (meaning a time description of six parameters being: latitude, longitude, altitude, pitch, yaw and roll) than cannot be matched by any other aircrafts able to carry payloads heavier than five tons while being capable of vertical take-off and landing, a good example of which are heavy conventional turbine-powered helicopters or heavy electrical quadcopters. Second part of this agility feature advantage would be an increased ability to execute trajectories that can be match by current state of art machine but with forces and or moments of force largely increased, by a factor of two, compared to electric powered aircrafts, which are the true benchmark we are measuring this invention against. This second sub-feature is of critical importance into being able to sustain high winds and or turbulences (being defined from the aircraft point of view as a fast direction changing wind vector, for instance a 90 degrees rotation in four seconds), which in turns have major impact in terms of the wind threshold beyond which aircraft is required to stay grounded, which is turns have major implication in the effective number of hours per year the craft can safely be operated.

The five feature that would arise from the present invention is higher availability, which can be measured as the number of successful courses with useful payload accomplished by a craft during a certain amount of time (typical reference could be a month). We aim at significantly increasing this value, by for instance a factor of two, compared to any aircrafts able to carry payloads heavier than five tons while being capable of vertical take-off and landing, a good example of which are heavy conventional turbine-powered helicopters or heavy electrical quadcopters.

The sixth feature that would arise from the present invention is higher acceptability, which can be measured as compound of both disturbances' reduction for neighborhood and hovered zones, plus significant decrease of risk for population. Again, this metric will be improved compared to aircrafts able to carry payloads heavier than five tons while being capable of vertical take-off and landing, a good example of which are heavy conventional turbine-powered helicopters or heavy electrical quadcopters.

In particular embodiments, the aircraft has eight propellers being distributed in a symmetrical fashion on both sides compared to the vertical plan containing the main forward-backward axis.

Such embodiments allow for a safety improvement compliant with prior goals settings as it enables a level eight redundancy factor. A significant contributor term in the probability of an aircraft losing its ability to maintain its altitude is roughly the probability of the specific propulsion devices used raised to the power of the minimal number of propulsion devices required not loose altitude too quickly. For the invention, each propeller being for instance designed to sustain 240% of their nominal required thrust load for the nominal payload under a zero-wing-lift contribution configuration, we see that the invention can handle a multitude of situations where the losses of three propulsion chains, or simply put engines, can be compensated in a manner such that flight safety remain uncompromised.

Basically, the conditions for an aircraft to remain airworthy are when the sum of thrust of operational propellers reached 8×100% thrust, when no propeller thrust exceeds 200% (we need spare power for instantaneous yaw and pitch control), when the center of mass matches the center of thrust while projecting on any horizontal plane, and when at least three propellers are operational (for yaw and pitch control).

For instance, a situation where propellers P0, P3, P5 and P6 are down is an airworthy one if P1, P2, P4, P7 are pushed to 200% load. Similarly, a situation where propellers P0, P2, P5 and P7 are down can be made airworthy, and symmetrical ones with respect to main symmetry plane and front plane equally.

When the aircraft has eight propellers capable of vectorized thrust, more emergency situations can be made airworthy. For instance, in case propellers P6 and P7 are down, the whole aircraft can be tilted in the main symmetry plane so that the center of mass matches again the center of thrust while projecting on a horizontal plane. In this case, the nose level of the aircraft is below its tail. Symmetrical situations with respect to main symmetry plane and front plane equally. A situation where propellers P5, P6 and P7 can be handled in a similar fashion, only adding another rotation. It is worth mentioning that quadcopters cannot exhibit such properties.

Such embodiments also allow for an efficiency improvement compliant with prior goals settings as it enables aerodynamic hull designs with lower apparent front section area, which plays a critical role in drag and therefore in efficiency since drag is the predominant counterforce resisting to aircraft move. This benefit occurs as the result of reducing the diameter of fans while increasing their number to keep a stable swept area and as a result of having propellers lined up in two lines on each side of the aircraft, the first propeller of each row shadowing the other ones in the row from an aerodynamic perspective while cruising front first at a stabilized altitude, which is the standard cruising configuration and the one of reference for energy-efficient flight.

Such embodiments also allow for a compactness improvement compliant with prior goals settings as it enables a reduced aircraft width at the expense of its length, compatible with target landing zones such as warehouse docks, streets, etc.

In particular embodiments of the invention, the aircraft propellers are electrically driven with electric motor directly mounted on fans shafts, the onboard power being generated by an array of hydrogen fuel cells, typically 40 fuel cells of 128 kW each, taken from Toyota Mirai Generation 3 (registered trademarks) car or from newly announced Hyzon (registered trademark) fuel cells.

Such embodiments allow for a safety improvement compliant with prior goals settings as it enables a four steps improvement: it reduced number of moving parts compared to a conventional propulsion chain including a gas-turbine driving a high-speed gearbox, itself driving a gimbal connected to the fan; it suppresses high-temperature fire-inducing component such as combustion chamber by relying on relatively low temperature components; its suppresses high-speed failure-prone component such as turbine shaft spools, high speed pinions, etc. whose rotational speed can reach speed higher than 25 kRPM and only relies on low speed propulsion fans whose rotational speed does not exceed 2.5 kRPM. By suppressing most mechanical components, it reduces sources of vibrations (like for instance aforementioned turbine and gearbox) which results in structure, piping and wiring fatigue. On top of that, the fact that the invention, in such particular embodiment, relies on 40 independent fuel cells stacks instead of two turbos (with unitary lower probability of failure) results in an order of magnitude more resilient onboard power source, the probability of critical failure being the unitary default probability at the power of the critical number of elements threshold where power generation does not match any more the flight ability requirements. In the configuration of the invention, one can state that the craft is not in a critical zone as long as 30 fuel cells are operational. Assuming that lifetime of a Proton Exchange Membrane is 25,000 h, we can roughly postulate (assuming a geometric probability distribution of failure) that hourly probability of default is 4e⁻⁵. On the other hand, the best-in-class engine helicopter failure rate is 0.35e⁻⁵.

The article: “Measuring Safety in Single- and Twin-Engine Helicopters” by Roy G. Fox, Chief Safety Engineer at Bell Helicopter Textron Inc, is hereby incorporated by reference.

Then hourly probability of airworthiness being compromised for twin turbo-engines helicopter is 0.35e⁻⁵, compared to (4e⁻⁵)\hat{ }10˜=1e⁻⁴⁴ for the invention discussed. The same type of calculation showing at least ten orders of magnitude gap holds true for non-engine airworthiness causes (especially the gearbox, switch mechanism, shafts, and clutches) compared to the invention that, in this particular embodiment, relies on eight distinct, easily switchable, power generation and propulsion lines.

Such embodiments allow for an efficiency improvement compliant with prior goals settings which can be appreciated first against conventional aircraft such as helicopters, second against batteries powered electrical quadcopters and alike.

Regarding the conventional aircraft, the total overall efficiency of fuel to rotor thrust chain, including as a major driver the small gas turbine efficiency (around 30%) and the gearbox efficiency (˜85%), is roughly 25% whereas the total efficiency from hydrogen fuel to rotor thrust is roughly ˜62%, having as main drivers the fuel cell efficiency now reported at 68%, the Variable Frequency Drive (typically ˜97%) and the Permanent Magnet Synchronous Motor (typically ˜95%), so more than twice the efficiency of internal combustion chain. Note that this also holds true against hydrogen as combustion engine fuel.

Regarding the batteries powered electrical quadcopters and multi-rotor aircrafts, energy efficiency is radically different as we will show in the following using a somewhat stylized argument. Let us consider two aircrafts, similar in all points, say electrical quadcopters, except for the power storage device, one using hydrogen and the other batteries. The total thrust of both aircrafts is ten tons, consuming an average two MW, the total empty weight, energy storage apart, of aircrafts is five tons. Then, for a goal of being able to fly 30 minutes, assuming perfectly efficient battery packs and using energy density of modern Cobalt Lithium-ion batteries of 200 Wh/kg, we end up with a battery pack weighting five tons. This means that in this configuration, the craft have almost no payload. On the other end, using LH₂ at 33 kWh/kg, we end up with a 90 kg fuel load, stored in 310 kg cryogenic tank and generating power using an 800 kg fuel cells array, resulting in a 3.8 available payload. Noting that the heavier the craft is, the larger the rotor blades must be, the less viscous the air seems to be relatively to the craft, the higher the thrust power per kg lifted. Therefore, we see that battery powered drones, although physically dominant in the small payload field, when reaching a certain threshold of payload in the range of three to five tons, tend to use almost all their energy to lift their own empty weight, are consuming an order of magnitude more energy for the same duty, and end up exhibiting net efficiencies near zero.

Such embodiments allow for a compactness compliant with prior goals setting since volume energy density for liquefied hydrogen is almost the double of that of now automotive standard compressed hydrogen at 700 bars. Since hydrogen storage tanks is the major driver for the total internal volume of the aircraft, this fuel compactness directly translates into tightened hull dimensions, which in turns allows to reduce aerodynamic drag during cruising and therefore contributes to further increase energy efficiency.

Such embodiments allow for an agility compliant with prior goals setting since the energy mass density of the hydrogen allows comparatively superior thrust to payload ratio compared to all vertical take-off and landing aircrafts not using hydrogen, as per the above discussion.

Such embodiments allow for an availability compliant with prior goals setting, mainly because of two factors. First, compared with electrical battery powered multi-rotors aircrafts or drones, the high energy density allows fewer refills (up to eight times less) for the same duty, enlarging operational time compared to battery packs. Second, H₂ tank filling is at least ten times faster than fast charging of a battery pack.

Such embodiments allow for a capacity compliant with prior goals setting, mainly because, compared to electrical battery powered multi-rotors aircrafts or drones, as shown in previous above discussion on efficiency, the LH₂ allows massive scaling up and tend to be increase its comparative advantage with size, weight, and operational range.

In particular embodiments of the invention, the aircraft main power generation system is coupled to a capacitor whose max instantaneous power rating is equivalent to the max power of the onboard power generation set and storage capacity is within the 20 seconds to ten min range, the purposes of which is to enable to store power from power generation set when larger than power consumption at the fans, and conversely to release complementary power in order to supplement aboard power generation set if needed. Alternatively, each eight aboard power generation sets would be equipped with their own capacitor.

Such embodiments allow for a safety gain compliant with prior goals setting for two reasons.

First reasons, it allows instantly available ultimate back-up storage for “last chance” landing, in case power generation set is down or alternatively can provide power for emergency avoidance situations requiring a jump from nominal to max power instantaneously.

Second reasons, it helps to reduce the sharpness of load increase on the power generation set, especially during the vertical and take-off phases and as a result, the smoothing of transients increases fuel cell stacks lifespan.

The article: “Diagnostic & health management of fuel cell systems: Issues and solutions” in Annual Reviews in Control, Volume 42, 2016, Pages 201-211, from D. Hissel and M. C. Pera (FEMTO-ST Institute—UMR CNRS 6174/FCLAB Research Federation—FR CNRS 3539) is hereby incorporated by reference.

Indeed, the extensive list of key parameters affecting fuel cell lifetime are, reactants purity aside: first cause is fuel and oxidant starvation (i.e. a sudden increase of load not covered sufficiently fast by an increase in oxygen and/or hydrogen feed, due to pump or compressor ramp-up delay); second cause is temperature supervision (cooling circuit and temperature probe has a thermal inertia and cannot detect overheating under a specific time scale, typically two seconds, which can result in delays adjusting cooling flow, resulting in turns into transient local overheating within the stack); third cause is hydration supervision (incoming oxygen inflow must be hydrated within a specific range and hydration is done in a passive way through a membrane, and has an inertia by itself, which itself put a limit on mass load increase per amount of time, the later rules warning against aggressive power ramp-ups); fourth cause is pressure variation (Since the electrolytic membrane is thin, less than 100 μm, and cannot bear a too high pressure drop between anode and cathode, processes must be sufficiently slow to let pressure adjust); fifth cause is current ripples (due to the output power converter, which are dampen by capacitor); sixth cause is open circuit voltage operation (high potential favors corrosion reactions at the electrodes), strongly advocating for the power generation set to rely on a storage device allowing smooth and sufficiently slow (typically two min) shut-down when aircraft becomes at rest.

Previously exposed six causes of fuel cells stack lifetime reduction are alleviated by capacitor, which, as a sum-up, allows fuel cell operation to be closer to stationary operation rather than automotive application, which is acknowledged for increasing the lifetime by a four factor, and reduce inflight default probability accordingly. With some redundancies in the system, we end-up with a net default probability reduction by an order of magnitude. Such embodiments allow for an efficiency improvement compliant with prior goals setting since oxygen starvation (and to a lesser extent hydrogen starvation) is the main cause for efficiency reduction of the fuel stack (typically efficiency drops from 68% down to 45% under high oxygen starvation conditions), highlighting the critical role of capacitor as dampener in the matter.

The article: “Technology Assessment of a Fuel Cell Vehicle: 2017 Toyota Mirai”, Argonne National Laboratory, Report #ANL/ESD-18/12 is hereby incorporated by reference.

Such embodiments allow for a compactness improvement compliant with prior goals setting since relying on capacitor may induce a downsizing of the power generation sets, the power cut being compensated by capacitor.

Such embodiments allow for an availability improvement compliant with prior goals setting since previously detailed lifetime improvement have a major effect on uptime of the aircraft.

In particular embodiments of the invention, the aircraft hydrogen storage is done under a liquefied form in cryogenic tanks.

Such embodiments allow for an efficiency improvement are compliant with our target of safety improvements compared to battery powered electrical aircrafts since reactive products are separated (H₂ and oxygen) instead of being tightly stored together (the main reason why high density Li-ion battery packs can start spurious combustion, even at rest). Another reason is that liquefied cryogenic is store in Low pressure tank, decreasing by at least an order of magnitude both probability and danger of an explosion compared to 70 MPa compressed hydrogen storage tanks. Compared to conventional solution using internal combustion engines. Another objective reason is that there is no high temperature point in the vicinity of storage inside fuselage that can spark fire c/kerosene+combustion chamber). In must also be stressed out that entire aircraft can be designed as Ex-i (intrinsic security for explosive atmosphere), meaning aircraft can safely be operated while massive H₂ leakage flowrate occurred. This later point cannot be replicated on internal combustion engine (whether using kerosene, hydrogen, or biofuels). Finally, seven redundancies can still be maintained by splitting the reservoir tanks in eight independent units.

Such embodiments allow for an energy improvement are compliant with our efficiency goal along the whole chain, since LH₂ has been successfully proven to as energy intensive as mechanically compressed 70 MPa Hydrogen by recent EU-funded works IDEALHY using standard cryogenic technology.

The article: “Efficient Large Scale Hydrogen Liquefaction,” by Ilka Seemann, Christoph Haberstroh and Hans Quack, Technische Universitaet Dresden Bitzer Chair of Refrigeration, Cryogenics and Compressor Technology D 01062 Dresden, Germany is hereby incorporated by reference.

This enables for liquefied hydrogen to be on par with compressed hydrogen from the supply chain point of view. Also, building on similar argument with the mass of hydrogen compared to that of batteries, we see that weight is magnification factor of aircraft efficiency and is therefore of critical importance, with effect being at least one order of magnitude. Since cryotanks have to tolerate only light internal pressure, and because thermal insulation can be achieved with lightweight insulation wool and reflective aluminum sheets and allowing a small boil-off, their required wall resistance is reduced by at least two orders of magnitude, resulting in an accordingly empty tank weight reduction.

The article: in “Future Energy (Third Edition), 2020” by Mary Helen McCay, Shahin Shafiee, chapters: 22.3.3. is hereby incorporated by reference.

Such embodiments allow for a compactness improvement since Liquid cryo-hydrogen has a higher volumetric density (71 kg/m³) compared to H₂ at 700 bar (42 kg/m³), of nearly a factor two. Since almost two thirds of the volume of the internal space of main fuselage of the present invention is filled with storage tank, using liquified hydrogen offers a significant benefit compared to any other craft with similar performance that would be based on compressed hydrogen. Liquefied Hydrogen, with a volume energy density of nearly 2200 kWh/m³, also offers consistent benefit (factor 4) over Li-ion batteries (500 kWh/m³), and therefore over all electrical batteries powered aircrafts.

Such embodiments allow for an availability improvement against all battery powered aircrafts since high energy density of liquefied Hydrogen allows for fewer refill for the same duty, enlarging operational time compared to battery packs (by a factor four if we consider similar volume devoted to energy storage, or by an order of magnitude if we consider similar weight devoted to energy storage). The article: in “eTransportation, Volume 1, August 2019, 100011”, “Lithium-ion battery fast charging: A review”, by Anna Tomaszewska, Zhengyu Chu, Xuning Feng, Simon O'Kane, Xinhua Liu, Jingyi Chen, Chenzhen Ji, Elizabeth Endler, Ruihe Li, Lishuo Liu, Yalun Li, is hereby incorporated by reference.

Energy storage filling is also of critical importance and can be measured by the ratio of the time needed to fill storage by the max on-flight time allowed by this replenishing. This ratio has of course direct impact on availability of the aircraft since it is a limiting factor of the later. Batteries (whether Li-ion, Li-cobalt, LiS, etc.) are limited on this matter by their C-rate, which appears to be intrinsically limited to a value of 4, meaning that charge speed cannot exceed the on-operation cruising discharge speed by a factor speed, putting a somewhat hard limit of four on the availability ratio. On the other LH₂ tank filling has been demonstrated as much faster, and with appropriate piping and pumps sizing. For a specific version of the present invention sized to have a six-ton payload and four hours flight-time in cruise mode, the expected liquefied H₂ tank volume is expected to be around 1,000 kg of hydrogen. For a specific density of liquid hydrogen of 71 kg/m³, a fluid velocity of six m·s⁻¹ and an inner diameter of 125 mm at the fill port section, the fill-in time is slightly less than 1.6 min. Therefore, the ratio of flight-time to grounded time is more than 150, as compared with four for electrical batteries powered aircrafts of similar thrust capacity, more than an order of magnitude better.

Such embodiments allow for a compactness improvement since the arguments developed for the point on Liquid Hydrogen impact on compactness have direct impact on the total quantity of energy that can be stored onboard and the subsequent range and payload capability.

In particular embodiments of the invention, the aircraft propellers are ducted, and revolution axis of ducting being kept coincident with fans rotation axis, even during an eventual tilting of the propellers.

Such embodiments allow for a safety improvement since for three distinct reasons, each of them of such importance that they almost make this duct mandatory.

First reason is that the casing, when designed as a fan blades containment ring, act as such. The importance of this feature has already been demonstrated on inflight turbofan blade-outs fatigue-induced incidents. The presence of a large volume of inboard fuel within the trajectories envelope of centrifugally expelled blades make the consequences of such incidents almost immediately catastrophic and compromise, at least, the lives of all passengers and crews, not to mention potential casualties on ground. In case the fuel is hydrogen (compressed or liquefied) the risk is magnified by the fact that fuel is under pressure. Another risk magnification factor is that, geometrically speaking, the risk for blade ruptured to cross a critical section of the craft, mainly the tanks, is considerably larger than, let's say, the one of a blade of a turbofan of Boing 737 to trigger an inflight hazard that would eventually result in all passengers being killed. The odds are basically 30% for the present invention (blade would likely be expelled almost perpendicular to rotational axis and then have a rough 25% to 50% body impacting probability) against a probability below 1% for a typical airliner, where everything can be design for such an event not triggering catastrophic consequences. It is worth noting that having the rotation plane of fans (the one containing all blades and perpendicular to fan axis) above or below the aircraft does not significantly reduce the risk since uncontained blade-out in one rotor could result in the destruction of another rotor. It also worth noting that this issue is virtually unknown for small quadcopters and light drones since polymers blades are far more tolerant than heavy load blades (which are more brittle) and because the energies of impact for such events are significantly lower.

Second reason is that ducting acts a deflector for most projectiles the fan blades would be susceptible of hitting. In most flight situation, like for instance first take-off phase, last landing phase and cruise, propellers are oriented so that they are facing sky (except for instance for the last row of propellers in cruise mode), and because the projectiles incidence vector are likely to be horizontal, the ducting acts as a shield in most of the cases.

Such embodiments allow for an efficiency improvement since fan ducting significantly increase propeller efficiency in hover and static thrust conditions, the importance of which is critical for vertical take-off and landing vehicles whose energy consumption is multiplied by a factor of four during hover/vertical ascending/vertical descending phases compared to cruising phase where wings can provide an efficient lift with greatly reduced energy consumption. The well-documented reasons for such an boost in efficiency of ducting can be summarized as per the following: it suppresses end of blades vortices which dissipate energy in turbulent flows, it suppresses the possibility for sucked air to immediately re-enter the blade suction surface by imposing a longer path, such a recirculation being a source of wasted power, it helps to contain the discharge side overpressure bubble and preventing it to leak around the fan and finally through convergent then divergent sections it increases airflow axial velocity and therefore allows more favorable angle of attack for blades.

Such embodiments allow for a compactness improvement since better efficiency can be traded back against a somewhat reduced swept area and therefore a smaller aircraft footprint.

Such embodiments allow for an acceptability improvement since it allows for better noise signature, which is of key importance to imagine the present invention being used as a mass transport solution, especially when considering that the key advantage of vertical take-off and landing vehicles resides in their ability to do point to point connection flights, with landing and taking-off zones in the centers of heavily populated areas, and immediate vicinity of habitations, offices and commercial zones. Noise signature improvement comes from three distinct reasons.

The article: “Narrowband noise spectra with expanded frequency scale” in NASA report entitled “Helicopter Main-Rotor Noise”, NASA Technical Publication, authors: Brooks, Thomas F. (Planning Research Corp. Hampton, Va., United States), Jolly, J. Ralph, Jr. (Planning Research Corp. Hampton, Va., United States), Marcolini, Michael A. (NASA Langley Research Center Hampton, Va., United States), Publication Date: Aug. 1, 1988) is hereby incorporated by reference.

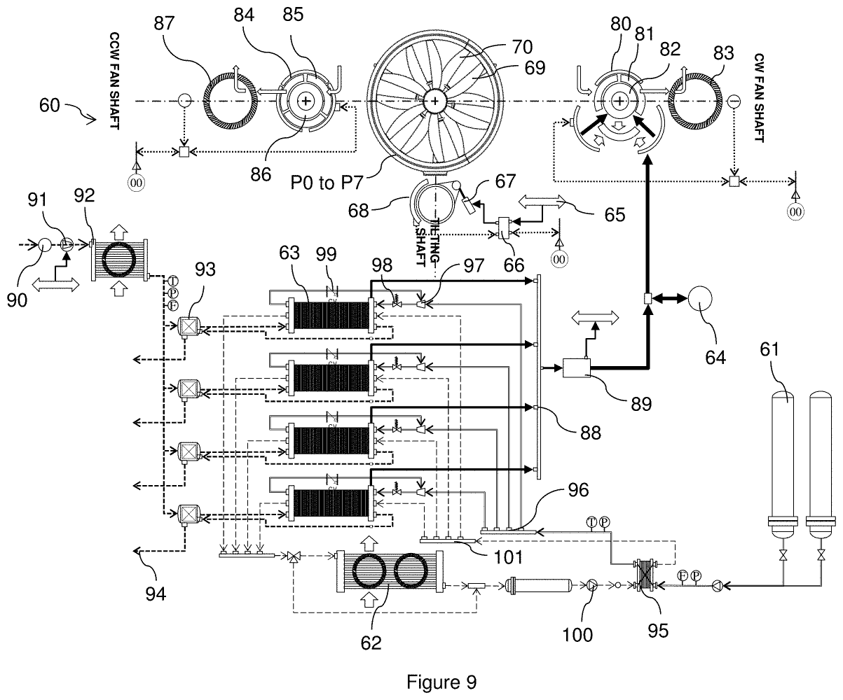

The first reason is the ability of the ducting to suppresses almost entirely (90% reduction for two meters of diameter fan with blade tip-duct inner wall clearance less than 10 mm) the Blade Vortex Interaction phenomenon (blade generate a vortex that persist in the atmosphere until it crosses the path of next blade of the fan, generating a low-frequency noise immediately identifiable as far field “helicopter” noise). This source is a somewhat dominant source in aerodynamic noise generated by helicopters and all vertical take-off and landing vehicle relying on fans (See for instance FIG. 9 of: “Narrowband noise spectra with expanded frequency scale” in report entitled “Helicopter Main-Rotor Noise”, NASA. The presence of a narrow clearance ducting blocks the generation of the vortex and therefore the associated aerodynamic noise generation.

The article: «Helicopter Rotor Thickness Noise Control Using Unsteady Force Excitation», authors: Yongjie Shi, Teng Li, Xiang He, Linghua Dong and Guohua Xu.

National Key Laboratory of Rotorcraft Aeromechanics, Nanjing University of Aeronautics and Astronautics, Nanjing 210016, China, in Appl. Sci. 2019 is hereby incorporated by reference.

The second reason is that another significant noise source is the so-called “thickness noise” which is the result of a sound wave pulse created by the repetitive rotary motion of the aft being displaced by the wing (blade) surface. It is primarily directed in the plane of the rotor (see for instance the chart entitled “Noise pressure generated by exciting force as a function of azimuthal angle,” in “Helicopter Rotor Thickness Noise Control Using Unsteady Force Excitation” report. Because of this specific angular distribution, noise absorption by a noise absorber placed on the ducting cylindrical inner wall would achieve a virtually total thickness noise absorption since all of the emission cone intersect the absorbing zone. An example of material to obtain sound absorption would be a composite structure of a microperforated panel and porous metal which, when used on an optimal sandwich structure with an actual total thickness of 36.8 mm, exhibits absorption coefficient of up to 97% in the frequency range from two kHz to six kHz.

The third reason is that the other sources of noise generation (loading noise, self-noise, etc.) are related to the square of the air velocity of air flowing around the blade, which is linear with distance to the fan axis, which results in higher noise generation near the end of blade (independently from the Blade Vortex Interaction phenomenon already discussed). Ducts inner wall noise absorber, because of their close distance from noise sources and a significantly solid view angle from source location (roughly 35% of 4π), add significant additional noise reduction capabilities.

In particular embodiments, the aircraft propellers can be equipped with noise cancellation devices located along the duct internal wall, and whose sound emission can be synchronized with blades passages. In such embodiments, noise sources not cancelled out by previously described means would be suppressed to reach almost silent operation.

In particular embodiments, the aircraft propellers ducts are equipped with flaps allowing to deviate the outlet air flow from said propellers to the left or to the right of aircraft. For that purposes the flaps have an essentially radial or diametral position at the duct outlet. For a diametral arrangement, bearings supporting the flap axis can both be integrated in the ducting. For a radial arrangement, flap axis and bearings can be integrated within an arm going from ducting to central propeller motor nacelle. The flaps, when in neutral position, is aligned with the propeller rotation axis. The rotation axis of the flaps is essentially horizontal and parallel to the main symmetry plane of the aircraft.

In particular embodiments, the aircraft propellers are able to tilt with an axis perpendicular to the main left-right symmetry plane of the aircraft.

In such embodiments, the rearmost propellers are tilted so that they are facing the forward propellers, which achieves horizontal thrust and prevents another propeller from being in the air stream propelled by each of these rearmost propellers.

In particular embodiments, all of the propellers are made steerable. In such embodiments, we have a safety gain since, in the event of the loss of a propeller allocated to horizontal thrust, any other propeller, which were idle so far, can be immediately started over for compensation. This on-the-fly inflight propellers re-allocation enables various emergency modes in order to cope with loss of propellers.

In particular embodiments, a left-right pair of propellers are made steerable. In such embodiments, we have a compactness gain since vectorized thrust allow to spare cruise propulsion dedicated fans (steerable propellers is used for vertical thrust during take-off/landing and then for horizontal during cruise), resulting in a lower overall footprint.

In particular embodiments, all of the propellers are made steerable. In such embodiments, we have an agility gain since, we can execute high torque maneuvers, since horizontal thrust component can be decoupled from vertical component, resulting in nearly arbitrary torque for horizontal rotations.

In particular embodiments, the aircraft has wings and eight propellers, all of them being steerable.

In such embodiments, we can define different combination of propellers titling angles and thrusts.

First combination shown in FIG. 1, parking state, the zero state when machine is grounded at rest, in a configuration where all propellers titling angles are 0 degree and propellers thrusts are zero.

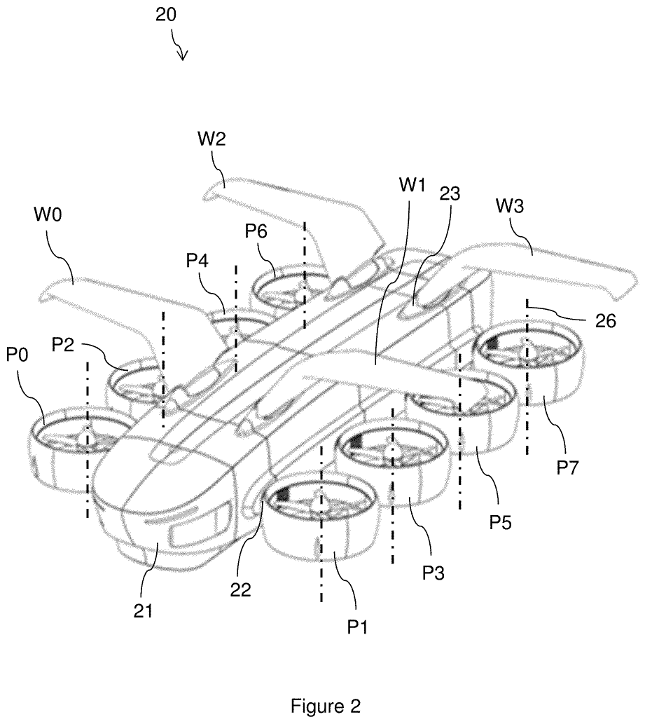

Second combination shown in FIG. 2, hover state, is a combination where all propellers titling angles are 0 degree and propellers thrusts are 100% (Note that propellers tilting angles can continuously vary around 0 degree to counter-balance wind loads: this is continuous adaptation on the 100 microseconds scale).

Third combination also shown in FIG. 2, pure vertical take-off is a combination where all propellers titling angles are 0 degree and propellers thrusts are 120%. Note that ascending speed relates directly to the over thrust compared to hover position and can be adjusted at will. Also, remark made for second combination still apply. Note that, in order to smooth the acceleration feeling in case of passengers' transportation, propellers thrust will follow a smooth curve whose time average would be a value of roughly 120%, a lot of common smoothing profiles, similar to those of lifters, could be applied. This ascending state is especially useful when taking-off from field surrounded by obstacles.

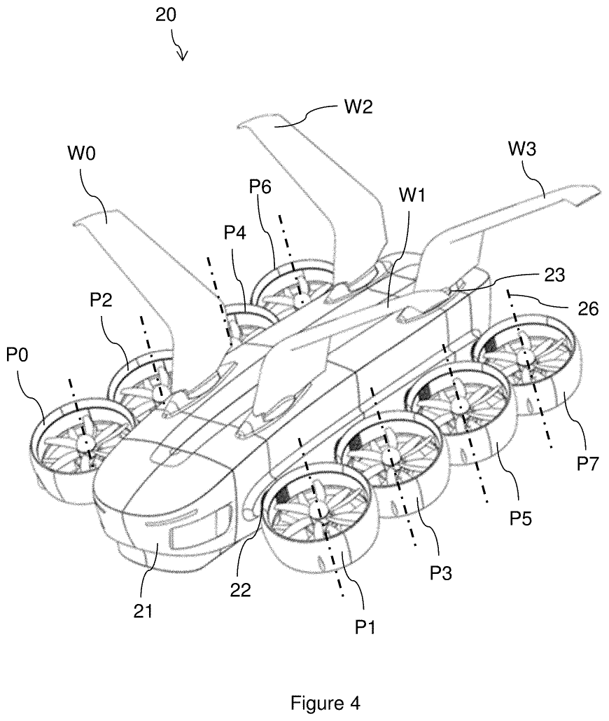

Fourth combination shown in FIG. 4, transitioning to vertical take-off, is a phase where, while still ascending, the aircraft is rounding its trajectory towards a horizontal cruising movement, but for which the wing contribution to lift can still be considered zero. This of course translates into a configuration whose parameters are continuously adapted, and of which, for the sake of simplicity, we will only give a time-averaged overview. For this combination, all propellers titling angles are 20 degrees and propellers thrusts are 130%, to maintain a vertical projection of thrust above 100%.

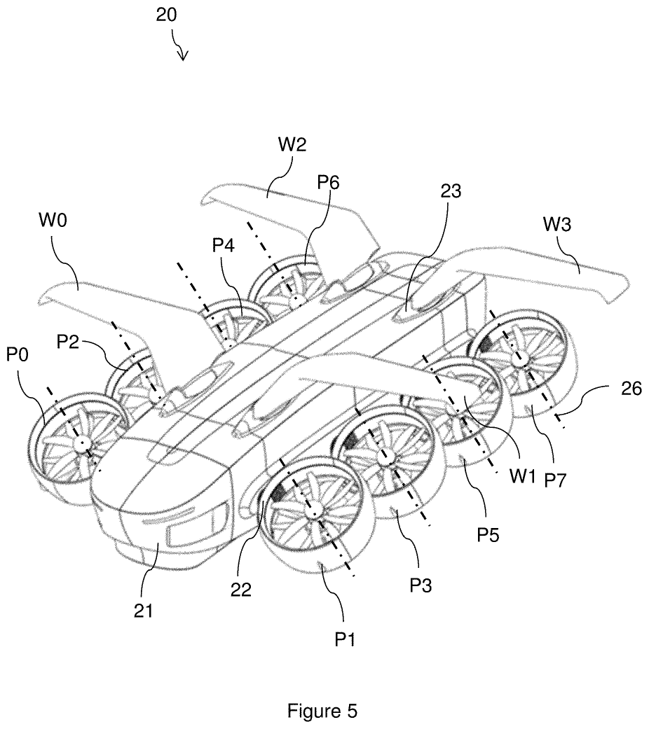

Fifth combination shown in FIG. 5, almost transitioned to horizontal flight, is a phase where, while the aircraft has almost finish to round its trajectory towards a horizontal cruising movement, and for which the wing contribution to lift now account for a rough 25% of the total required lift. This of course translates into a configuration whose parameters are continuously adapted, and of which, for the sake of simplicity, we will only give a time-averaged overview. For this combination, all propellers titling angles are 30 degrees and propellers thrusts are 120%.

Sixth combination, final re-configuration before cruise, is a phase where the aircraft prepares for cruising that happens when aircraft has gained sufficient speed and wings lift is higher than 75% of those required. In this configuration, propellers zero to five tilting angles goes from 30 degrees to 0 degrees in a continuous motion and their thrust slowly vanish as the wing lift-off is converging towards 100%. At the same time, propellers P6 and P7 have their titling angles going from 30 degrees to 90 degrees and their thrust going converging to 50%.

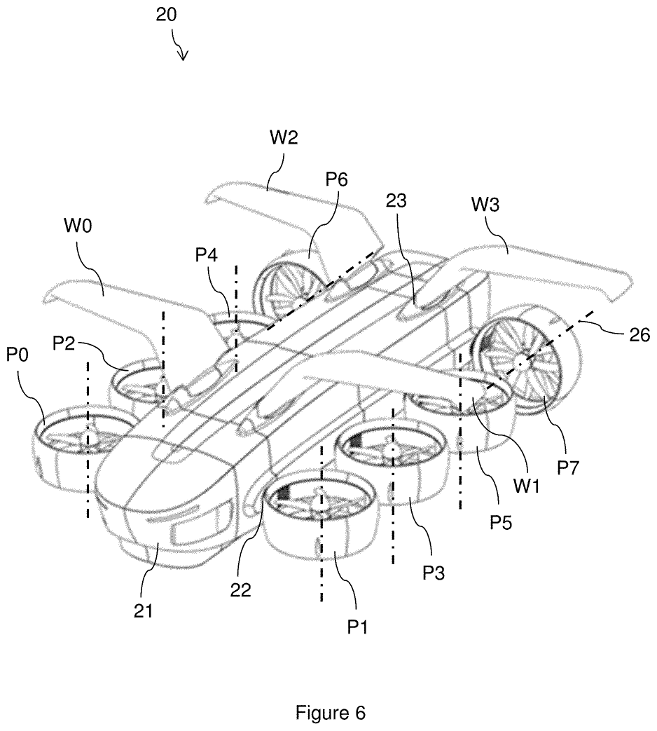

Seventh combination shown in FIG. 6, cruise, is a phase where the aircraft propellers parameters remain quite steady with propellers P0 to P5 having tilting angles at zero and their thrust zeroed, and propellers P6 and P7 have their titling angles set at 90 degrees and their thrust stabilized at 50%.

Eighth combination, which is essentially a mirror phase of sixth phase, happens when decelerating and preparing for landing. In this configuration, propellers P0 to P5 tilting angles goes from 0 degrees to −30 degrees in a continuous motion and their thrust slowly transition from zero to 110%. At the same time, propellers P6 and P7 have their titling angles going from 90 degrees to −30 degrees and their thrust increase to 110%. During this phase, the aircraft is breaking in mid-air and wing lift is reducing.

Ninth combination, which is essentially a mirror phase of fifth phase, is a phase where the aircraft is starting to round its trajectory to the ground, and wing contribution to lift reduce to roughly 25% of the total required lift. This of course translates into a configuration whose parameters are continuously adapted, and of which, for the sake of simplicity, we will only give a time-averaged overview. For this combination, all propellers titling angles are −30 degrees and propellers thrusts are 105%.

Tenth combination, pure vertical landing is a combination where all propellers titling angles are 0 degree and propellers thrusts are 95%. Note that descending speed relates directly to the over thrust compared to hover position and can be adjusted at will. Also, remark made for second state still apply). Note that, in order to smooth the feeling of fall in the case of passengers' transportation, propellers thrust will follow a smooth curve whose time average would be a value of roughly 95%, a lot of common smoothing profiles, similar to those of lifters, could be applied. The thrust profile is well adapted when ending with a value of 100% and time derivative of almost zero. This ascending state is especially useful when lading on a field surrounded by obstacles.

Eleventh combination, low speed hover, is combination where all propellers titling angles are 0 degree and propellers thrusts are 100%.

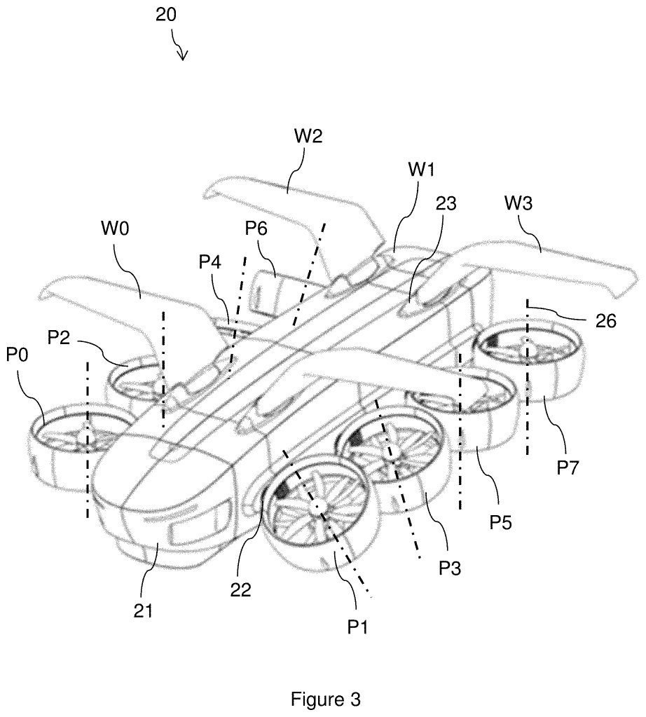

Twelfth combination shown in FIG. 3, high-speed U-turn to the left side of the aircraft, is combination where propellers titling angles are, in ascending indices order: 0, 0, 30, −30, 30, −30, 0, 0 degrees and propellers thrusts are 95%, 95%, 130%, 130%, 130%, 130%, 95%, 95%. The same combination with opposite tilting angles gives a high-speed U-turn to the left. More generally, at least the frontmost propeller, P0 or P1 on one side of the aircraft and at least a rearmost propeller, P8 or P7 respectively, on the other side of the aircraft are oriented along oblique axes having opposite tilting angles.

In particular embodiments, a left-right pair of propellers are made steerable. In such embodiments, we have an acceptability gain since vectorized thrust allow deck remains horizontal all the time, even during transition from vertical flight to horizontal flight. This capability is of importance for passengers' comfort and for care of patients.

In particular embodiments of the invention, the aircraft propellers have counter-rotating fans.

The article: “Experimental comparison between a counter-rotating axial flow fan and a conventional rotor-stator stage», authors: Juan Wang, Florent Ravelet, Farid Bakir. DynFluid laboratory ENSAM Paris. Presented at the 10th European Turbomachinery Conference, April 2013, Lappeenranta, Finland, is hereby incorporated by reference.

Such embodiments allow for an efficiency improvement since counter-rotative fans allow for the kinetic rotational energy of the whirl leaving the first fan to be recovered efficiently by the second one, increasing energy efficiency. Typical improvement is typically a factor 1.4. For instance, this study found that the peak static efficiency of counter-rotating configuration is 67% whilst the peak static efficiency of the equivalent front rotor alone is 45%.

Such embodiments allow for a compactness improvement by piling-up of two fans per propellers, accounting for a mere doubling of the fan-swept areas. Compactness has also the side effect of reducing fan diameter and therefore reducing aerodynamic drag.

Such embodiments allow for an acceptability improvement since for the same thrust, counter-rotating configuration allows lower tip speed and therefore significantly reduced noise generation.

In particular embodiments, the fuselage is equipped with pairs of wings symmetrical with respect to the main symmetrical plane. In such embodiments, we have a safety gain since wings offer an additional lift for emergency landing in case of failure of some of the propellers.

In such embodiments, we have an energy efficiency benefit since during cruse wings can provide the total require lift at a fraction of the energy cost of a sustentation fully relying on propellers. This fraction is roughly equal to ¼ for six tons payload configuration of the present invention.

In such embodiments, we also have an acceptability benefit since they allow for a huge noise reduction coming from the shut-down on three out of four propellers during cruise.

In such embodiments, we also have a substantial capability benefit since they increase substantially the range by enabling efficient Horizontal fly.

In particular embodiments, the connection between the wings and the fuselage is done on the upper part of the fuselage, with wings emerging up from fuselage with an angle of 45° with respect to the top plane in order to give propellers sufficient room to both tilt and have a free volume for air suction not hindered by the presence of the wing. As soon as this later condition is met, the wing curls to horizontal direction, having most of its surface on this direction. In such embodiments, the wing shape and location allows for good compliance with our compactness goal settings.

In particular embodiments, wings can be any number of pairs, and for instance can be two pairs with a tandem arrangement.

In particular embodiments, wings tips are equipped with a terminal winglet making a pronounced angle (typically more than 45 degrees) with the wing main horizontal section and pointing upward or downward (both being acceptable). In such embodiments, the winglet prevents, at least partially, wing tip vortex formation, and participate in the energy efficiency of the flight.

In particular embodiments, wings are entirely static parts and rearmost propellers are made tiltable. In such embodiments, for any given acceptable cruise speed, the adjustment of the lift thrust from wings is performed by controlling the pitch of the aircraft, the later one is done by tilting the rearmost propellers around their +90° position so they induce slightly negative or positive pitch moment to maintain the target pitch angle.

In particular embodiments, wings are equipped with flaps that allows for a change in wing cross section profile camber. In such embodiments, the wing flaps are used to adjust wing lift characteristics without modifying aircraft pitch—but pitch angle control can also be used in complement as explained above.

In particular embodiments, wings are equipped with flaps similar to rear plane elevators that allows for a change of pitch. In such embodiments, wings lift is regulated by airplane pitch angle by acting of these elevators.

In particular embodiments, wings, while unfolded in maximum lift position, comprise a rotating horizontal section similar to those of airliners stabilizers rear horizontal wings. In such embodiments, wings lift is regulated by airplane by directly adjusting attack angle of wings via the rotation axis.

In particular embodiments, wings are equipped with a hinge with enable the folding of the wings. In such embodiments, the wing folding allows for a projected wingspan tighter than those of the aircraft without wings, and this during the final ascending or descending phase of take-off or landing and while in parking position. In such embodiments, the wing hinge allows for wing to tilted upward by an angle of 25 degrees in the situation where propellers have angles in the [−30°, +30°] range and have power above 75%, typically when low-speed hovering, on final descending phase of landing or during first ascending phase while taking-off.

In particular embodiments, wings are equipped with one or more hinges allowing for change in geometry of the wing whose primary objective is to reduce ground-projected wingspan when approaching the ground. In such embodiments, the wings can be deployed to a wingspan that can reach four times the axial length of fuselage, providing high lift-off even at low speed, in turn allowing for ultra-low energy consumption, and participate in the energy efficiency of the flight.

In particular embodiments, the aircraft is equipped with a docking system enabling docking detachable payloads and therefore switch of payloads.

FIGS. 1 to 6 show an aircraft 20 that can either be manned, remotely controlled, or fully unmanned and relying on an autonomous inboard artificial intelligence controlling all aspects of flights.

The aircraft 20 comprises a fuselage 21 defining a fuselage main axis and eight propellers P0 to P7 mechanically connected to the fuselage. Each of the propellers P0 to P7 is associated with a tilting actuator 22 for rotating this propeller about a rotation axis 24 making an angle of less than 45 degrees with a plane perpendicular to the fuselage main axis. Preferably, this rotation axis 24 is in a plane perpendicular to the fuselage main axis.

By rotating the steerable propellers, the aircraft 20 can rotate, compensate for wind during take-off and landing, accelerate in flight, hover, and reduce its flight speed. The presence of eight propellers improves the aircraft's stability as well as its safety in the event of a propeller failure.

The fuselage has a forward and a rear portion defining a forward-to-rear order of propellers, respectively, at the front, P0 and P1, then P2 and P3, then P4 and P5 and, at the rear, P6 and P7.

In particular embodiments where at least one propeller is not associated with a tilting actuator 22, the rearmost propellers, P6 and P7, are among the at least two propellers associated with tilting actuators. Orienting the rearmost P6 and P7 propellers to achieve horizontal thrust prevents another propeller from being in the flow of air propelled by each of these rearmost propellers P6 and P7.

In particular embodiments, the aircraft comprises, for each of at least four, but not all, of these propellers, a tilting actuator for rotating that propeller about a rotation axis in a plane perpendicular to the fuselage main axis.

This improves the handling of the aircraft.

As explained above, in cruise-flight modes, the six forward propellers, P0 to 05, are oriented along vertical axes and the two rearmost propellers, P6 and P7, are oriented along horizontal axes. The six forward propellers thus produce minimal drag. Still in cruise flight, the two front propellers P0 and P1 are activated to provide vertical thrust, the intermediate propellers P2 to P5 between the front propellers P0 and P1 and the rearmost propellers P6 and P7 are not activated and the two rearmost propellers P6 and P7 are activated to provide horizontal thrust. This distribution of the activations of the propellers, four of which are off, makes it possible to increase the range of the aircraft 20.

In the first embodiment illustrated in FIGS. 1 to 9, the aircraft 20 comprises wings W0 to W3 associated with tilting actuators for rotating wings about rotation axes 25 parallel to the fuselage 21 main axis. These wings W0 to W3 make it possible to increase the range of action of the aircraft 20 as certain propellers, notably the intermediate propellers P2 to P5, are stopped, the wings providing the necessary lift.

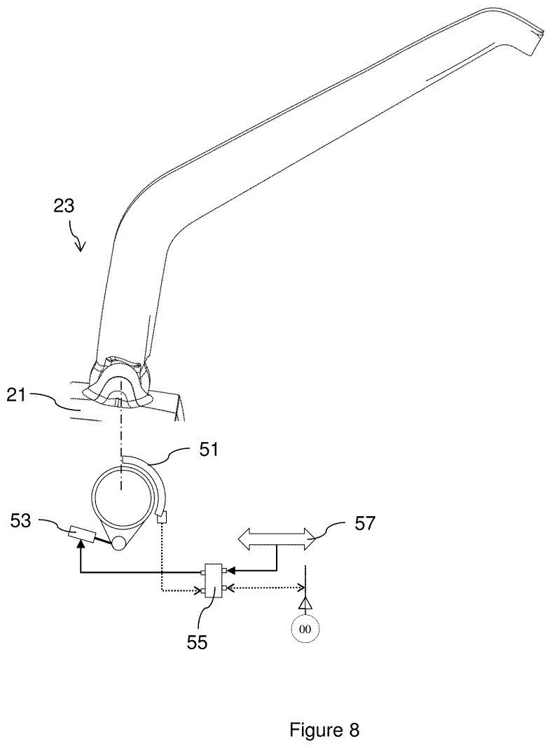

In particular embodiments such as that illustrated in FIGS. 1 to 9, the wings W0 to W3 are positioned above a plane defined by the propellers and present a curved shape with a concavity pointing downward. As illustrated in FIG. 8, these wings have a “V” shape, with a first flat part touching the root 23, an angle of substantially 45°, a second flat part substantially horizontal in flight configuration, and, after a second angle of substantially 60°, a winglet reducing the drag induced by the lift without increasing the wing span too much. This curved shape increases the distance between the wings and the propellers and reduces the impact of the wings on the airflow into the propellers.

Preferably, the maximum wingspan of the wings W0 to W3, in cruise flight, is less than the length of the aircraft 20. Preferably, the ratio of the maximum wingspan to the length of the aircraft 20 is less than 0.75. The aircraft 20 thus has a high compactness, both in flight and on the ground, which allows a denser parking and a reduction of the risks of collision.

The tilting actuators are, for example, of the brand Orientalmotor (registered trademark).

In particular embodiments, such as the one shown in FIGS. 1 to 9, the aircraft 20 comprises at least one hydrogen tank 61 and at least one fuel cell 63 for supplying power to the propellers P0 to P7. The aircraft 20 thus does not emit greenhouse gases and does not pollute its environment, neither during take-off, nor during flight, nor during landing. The aircraft 20 can thus take off, land, and fly in cities or in particularly fragile sites. Preferably, the hydrogen tanks 61 keep cryogenic hydrogen (25° K). Alternatively, the tanks 61 maintain liquid hydrogen under pressure, for example 700 bars.

Preferably, the aircraft 20 also comprises a capacitor 64 for supplying electrical power to the propellers, charged by at least one fuel cell. This capacitor 64 stores electrical energy greater than the energy consumed by all of the propellers P0 to P7 for ten seconds, and preferably twenty seconds, when the aircraft 20 is in hover flight. This capacitor 64 compensates for the time needed by each fuel cell 63 to reach full power. For example, the capacitor 64 is one of those marketed by the company ISKRA (registered trademark).

In particular embodiments, such as that illustrated in FIGS. 1 to 9, at least one propeller and, preferably, all the propellers P0 to P7, comprises two rotors 69 and 70 and a motor for rotating the rotors in opposite directions of rotation about rotation axis 26. This counter-rotating arrangement of the propellers reduces the noise caused by the aircraft 20.

In particular embodiments, the fuselage comprises a removable nacelle docking system (not shown). The aircraft can thus quickly change its payload and move from a people-carrying mission to a cargo-carrying, rescue, or fire-fighting mission, for example.

Preferably, the aircraft 20 comprises an attitude compensator which distributes electrical power supply powers to the propellers P0 to P7 to counterbalance variations in attitude, for example due to turbulence or wind. This improves the comfort of any passengers and the safety of any goods being transported. The aircraft can lift different types of payloads (container, water tanks, ambulance, etc.) thanks to these interchangeable nacelles in a few seconds.

The interchangeable nacelles can be used for the following applications:
sanitary evacuations,
rescue missions on land, sea, and mountains,
freight/logistics,
tourism,
public transport,
civil protection mission or
fighting fires and other natural or industrial disasters.

The nacelle is born by the aircraft by an ILIDS (acronym for International Low Impact Docking System). Alternatively, the docking system can be a simple sling or an electromagnetic suction cup.

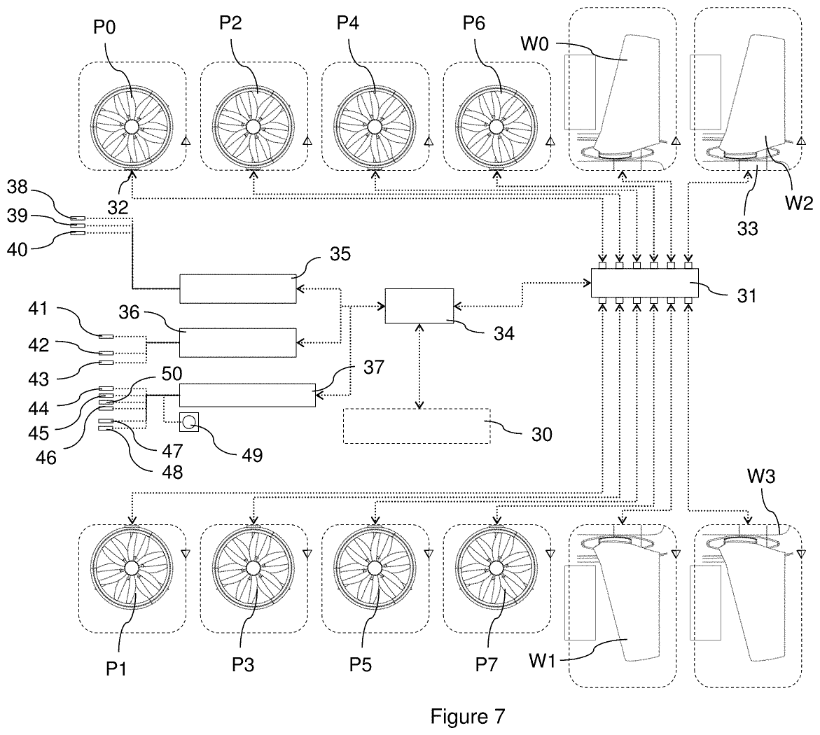

It can be seen in FIG. 7 that the control and command members of the various wing tilting actuators 33 and the propeller tilting actuators 32 of the aircraft 20 illustrated in FIGS. 1 to 6 comprise a movement controller 31, a main controller 34, a user interface 30 for a pilot to take control of the aircraft 20, a communication controller 35, a collision controller 36, and a geolocation, ground data acquisition and modelling module 37.

The communication controller 35 is connected to a 4G cellular data network 38, a 5G cellular data network 39, and a satellite communication network 40.

The collision controller 36 is connected to an Emergency Locator Transmitter (ELT) 41, a Traffic alert and Collision Avoidance System (TCAS) 42, also known as an Airborne alert and Collision Avoidance System (ACAS), an on-board instrument designed to avoid mid-air collisions between aircraft, and a high frequency radio 43.

The module 37 is connected to a radio altimeter (RA) 44, a front LIDAR 45, a back LIDAR 46, a Global Positioning System (GPS) 47, an Inertial Navigation 49, an Automatic Direction Finder (ADF) 48 and a Distance Measuring Equipment (DME) 50.

FIG. 8 shows the pivoting members of a wing W0 to W3. These members comprise an auxiliary power source 57, an angle controller 55, a tilting actuator 53, an absolute angular position encoder 51 connected to the angle controller 55.

It can be seen in FIG. 9 that the power-to-thrust systems 60 includes, for each one of the propellers P0 to P7, a tilting shaft, a clockwise rotating shaft connecting the clockwise rotating fan 69 to the motor 82, and a counter-clockwise rotating shaft connecting the counter-clockwise rotating fan 70 and the motor 86.

The power-to-vectorized-thrust system, or simply put propeller, includes a hydrogen loop, with liquid cryogenic hydrogen flowing from tanks 61 to a heat exchanger 95 that vaporizes it and supplies it to a manifold 96 that distributes it to the gas ejector 97 through a safety shut-down valve 98 to the fuel cells 63 hydrogen internal channels, those later channels are then drained back to the suction side of the gas ejector 97 through a check valve 99. The supply-drain system ensures constant flow through the fuel cell channel and improve fuel distribution homogeneity.

The power-to-vectorized-thrust system includes an air loop, that starts in open atmosphere, with fresh air sucked through air filter 90, then compressed to an approximate four bar absolute pressure by an air compressor 91 (typically a centrifugal compressor driven by high speed permanent magnet motor for high power-to-weight ratio), then cooled down through a cross-flow air-chilled tube and fins heat exchanger 92, then distributed to membrane air-hydrating system 93 (best operational conditions for fuel cells require a roughly 20% moisture content in incoming air) that allows outgoing water from the fuel cells 63 to be re-introduced into the air entering the fuel cells through a counter-flow arrangement with a permeable membrane arrangement. Air in excess compared to the chemical reaction producing water, as well as water produced that get carried away with the air flow outflowing from fuel cells, is release to atmosphere via the exhaust 94.

The power-to-thrust system includes four cooling loops. First cooling loops is a dual open atmosphere loop flowing through the dissipators 81 and 85. These dissipators 81 and 85 drain heat from clockwise and counter-clockwise motor 82 and 86, as well as from their variable frequency drive 80 and 84. Fans ensuring atmospheric cooling air flow are directly connected to the main torque shafts, that is to say clockwise cooling fan 83 is driven by clockwise fan shaft and counter-clockwise cooling fan 87 is driven by counter-clockwise fan shaft.

Second cooling loop is an open atmosphere counter-flowing through the incoming air cooling heat exchanger 92. Third cooling loop is a liquid-coolant loop flowing through fuel cells 63, releases heat through crossflow heat exchanger 62 to a fourth open air cooling loop, then go through pump 100, then through hydrogen vaporizer 95 before being distributed back to fuel cell via manifold 101.

The power-to-thrust system includes an electrical loop, conveying power from fuel cells 63 to a voltage booster 89 via electrical buses 88. High voltage power can be stored or drained, depending on instantaneous needs of the thrust system, in the capacitor 64. High voltage power is supplied to the variable frequency drivers 82 and 86 of, respectively, the clockwise rotating fan motor 80 and the counter-clockwise rotating fan motor 84. Voltage booster 89 also supply power on the power loop of the auxiliaries 65.

Each propeller P0 to P7 is associated with an angle controller 66, a tilting actuator 67 and an absolute angle position encoder 68 connected to the angle controller 66.

Voltage booster also provides power to auxiliaries, like for instance the tilting actuator 67.

In the second embodiment illustrated in FIGS. 10 and 11 in top views, the aircraft 72 comprises a fuselage 73 defining a fuselage main axis 77, six propellers P10 to P15 mechanically connected to the fuselage, and, for each of only two of these propellers, P12 and P13, a tilting actuator 74 for pivoting this propeller about a rotation axis 75 making an angle 76 less than 45 degrees with a plane perpendicular to the fuselage 73 main axis 77.

In this second embodiment, the rearmost propellers P14 and P15 are not part of the propellers equipped with tilting actuators.

In this second embodiment, the aircraft 72 does not comprise wings.

Preferably, the aircraft 72 comprises at least one hydrogen tank and at least one fuel cell for powering the propellers and a capacitor for powering the propellers, as described with respect to the first embodiment. The propellers P10 to P15 comprise only one rotor and a motor for rotating this rotor. Preferably, the fuselage comprises a docking system for fixing removable nacelles.

As may be understood from the above description, the aircraft of the invention comprises a fuselage defining a fuselage main axis, at least six propellers mechanically connected to the fuselage, and, for each of at least two of these propellers, a tiling actuator for rotating this propeller about a rotation axis making an angle of less than 45 degrees with a plane perpendicular to the fuselage main axis, thus allowing for a vectorized thrust, that can also generate pitch and yaw torque. Preferably, the fuselage having a forward portion and a rear portion defining a forward to rear order of propellers, each one of rearmost propellers is part of the at least two propellers associated with the tilting actuators. Preferably, at least four propellers associated with tilting actuators. Preferably, all of the propellers are among the at least two propellers provided with steering actuators.

Any combination of the technical features of the various embodiments and variants thereof provide further embodiments and variants of the present invention.

As can be understood from the above description, the use of the aircraft subject of the invention for emergency missions, public transport and goods transport allows the decongestion of cities and road transport routes, as well as the emergence of an environmental economy and a new market for fluid, fast and clean air transport, competitive with land transport. The aircraft is thus a powerful tool for the vertical integration of logistic flows by air.

1. Aircraft comprising a fuselage defining a fuselage main axis, at least six propellers mechanically connected to the fuselage, and, for each of at least two of these propellers, a tiling actuator for rotating this propeller about a rotation axis making an angle of less than 45 degrees with a plane perpendicular to the fuselage main axis, thus allowing for a vectorized thrust, that can also generate pitch and yaw torque.

2. The aircraft of claim 1, wherein the fuselage has a forward portion and a rear portion defining a forward to rear order of propellers, wherein each one of rearmost propellers is part of the at least two propellers associated with the tilting actuators.

3. The aircraft according to claim 1, which comprises at least four propellers associated with tilting actuators.

4. The aircraft of claim 1, wherein all of the propellers are among the at least two propellers provided with steering actuators.

5. The aircraft of claim 1, wherein the fuselage has a forward portion and a rear portion defining a forward to rear order of propellers, which comprises eight propellers, each of said propellers being associated with a tilting actuator.

6. The aircraft of claim 5, wherein, in cruise flight, six forward propellers are oriented along vertical axes and two rearmost propellers are oriented along horizontal axes.

7. The aircraft of claim 6, wherein, in cruise flight, two rearmost propellers are activated to provide horizontal thrust, and six forward propellers are not activated.

8. The aircraft of claim 6, wherein, between take-off and cruise flight, the six forward propellers are successively oriented along vertical axes and activated to provide vertical thrust, then oriented with a progressive tilting angle and activated to provide oblique thrust and then oriented with a degressive tilting angle until being oriented along vertical axes.

9. The aircraft of claim 6, wherein, between cruise flight and landing, the six forward propellers are successively oriented with a progressive tilting angle and activated to provide oblique thrust and then oriented with a degressive tilting angle until being oriented along vertical axes and activated to provide vertical thrust.

10. The aircraft of claim 6, wherein during U-turn, at least a frontmost propeller on one side of the aircraft and at least a rearmost propeller on the other side of the aircraft are oriented along oblique axes having opposite tilting angles.

11. The aircraft of claim 1, which comprises wings positioned above a plane of the propellers.

12. The aircraft of claim 11, wherein the wings have a curved shape with a concavity facing downward.

13. The aircraft of claim 11, wherein a maximum wingspan is less than a length of the aircraft.

14. The aircraft of claim 1, which comprises wings associated with tilting actuators for rotating wings about axes of rotation parallel to a fuselage main axis, resulting in ability to tighten wingspan in flight phase where less relying on wing lift.

15. The aircraft of claim 1, wherein each propeller comprises ducted fans.

16. The aircraft of claim 15, wherein each propeller comprises counter-rotating fans.

17. The aircraft according to claim 1, which comprises at least one cryo-hydrogen tank and at least one fuel cell for powering the propellers.

18. The aircraft according to claim 17, which comprises a capacitor for supplying electrical power to the propellers, charged by at least one fuel cell, said capacitor storing electrical energy greater than the energy needed by all the propellers for ten seconds of hovering flight.

19. The aircraft of claim 1, wherein the fuselage comprises a removable nacelle docking system.

20. An aircraft comprising
a fuselage defining a fuselage main axis, comprising a removable nacelle docking system,
at least eight propellers comprising counter-rotating ducted fans, said propellers being mechanically connected to the fuselage, and, for each of the propellers,
a tiling actuator for rotating this propeller about a rotation axis making an angle of less than 45 degrees with a plane perpendicular to the fuselage main axis, at least one cryo-hydrogen tank and at least one fuel cell for powering the propellers, and
a capacitor for supplying electrical power to the propellers, charged by at least one fuel cell, said capacitor storing electrical energy greater than the energy needed by all the propellers for ten seconds of hovering flight,
wings positioned above a plane of the propellers, the wings having a curved shape with a concavity facing downward, the wings being associated with tilting actuators for rotating wings about axes of rotation parallel to a fuselage main axis, resulting in ability to tighten wingspan in flight phase where less relying on wing lift; and
wherein, in cruise flight, six forward propellers are oriented along vertical axes and two rearmost propellers are oriented along horizontal axes and activated to provide horizontal thrust, and four intermediate propellers between the forward and rearmost propellers are not activated;
wherein, between take-off and cruise flight, the six forward propellers are successively oriented along vertical axes and activated to provide vertical thrust, then oriented with a progressive tilting angle and activated to provide oblique thrust and then oriented with a degressive tilting angle until being oriented along vertical axes.
